(19) United States
(12) Patent Application Publication
(10) Pub. No.: US 2022/0181046 A1
(43) Pub. Date: Jun. 9, 2022

(54) MANUFACTURING METHOD OF A SCREENING TAPE FOR AN UNSHIELDED SIGNAL TRANSMISSION CABLE

(71) Applicants: Dongguan Ching Tai Electric Wire & Cable Co.,Ltd., Dongguan City (CN); Ching Tai Electric Wire & Cable Co., Ltd., New Taipei City (TW)

(72) Inventors: WEN-CHANG LEE, New Taipei City (TW); WAN-RU LIAO, New Taipei City (TW)

(21) Appl. No.: 17/111,925

(22) Filed: Dec. 4, 2020

(51) Int. Cl. H01B 11/10; H01B 11/08; H01B 13/26

(52) U.S. Cl. CPC H01B 11/1008; H01B 13/26; H01B 11/085; H01B 11/1091

(57) ABSTRACT

A manufacturing method of a screening tape for using in an unshielded signal transmission cable without a drain wire for transmitting analog or digital signals comprises the following steps: providing an insulating substrate having a continuous flat surface; providing a continuous conductive layer; providing an adhesion layer in a discontinuous manner on the continuous flat surface of the insulating substrate or on the continuous conductive layer; bonding the continuous conductive layer and the insulating substrate through the adhesion layer to form a laminated structure comprising the insulating substrate, the adhesion layer, and the continuous conductive layer; and stretching the laminated structure in a longitudinal direction of the laminated structure to divide the conductive layer into multiple discrete conductive blocks that are mechanically and electrically isolated from each other.

### BACKGROUND OF THE INVENTION

### Technical Field

The present invention relates to a screening tape in a signal transmission cable and a manufacturing thereof. More particularly, the present invention relates to a screening tape and a manufacturing method thereof and an unshielded signal transmission cable using the same.

### Description of Related Art

The signal transmission cable is increasingly affected by electromagnetic interference as the transmission frequency increases. A known method to protect the inner transmission lines in the cable is to provide a metal shielding tape. The metal shielding tape with drain wire is used for grounding and wraps around the inner transmission lines to protect these lines from the external disturbance source and to block the electromagnetic interference applied to external apparatus from these lines. The structure of such cable therefore forms a shielded signal transmission cable.

Another known method is the unshielded technique, i.e. without grounding. For instance, in an existing unshielded telecommunications cabling system, especially the unshielded signal transmission cables or local area network (LAN) cables used in commercial building, industrial premises and data centers, are arranged in a manner that multiple cables are bundled together. When the data speed of the unshielded signal transmission cables increases, the mutual interference between the cables increase accordingly. In attempt to retain the transmission quality, a discontinuous metal screening tape used in the unshielded signal transmission cable without the need of the grounding is developed. The mutual interference between unshielded signal transmission cables can be lowered by increasing the diameter of the cables and the distance between cables. However, in this manner, the amount of material for the cables significantly increases and the number of cables disposed in the pipelines decreases. By using the discontinuous metal screening tape, the alien cross-talk among cables can be inhibited without increasing the diameter of the cables.

In a known discontinuous metal screening tape, the conductive layer is separated into sections by gaps. As shown in U.S. Pat. No. 5,473,336, entitled “Leaky Cable”, a technical solution for a leaky cable as a distributed antenna is disclosed. A shielding layer of aluminum-polypropylene tape wraps around a coaxial cable, twin, twist pair, or other suitable transmission cable that is not fully shielded. The aluminum tape has horizontal and vertical periodic gaps, allowing the signal to be leaked out as were in an antenna. Although the leaky cable uses discontinuous metal screening tape, its object or function is different from the transmission cable. The leaky cable spreads the signal from the inside out through electromagnetic waves, while the metal screening tape shields electromagnetic waves from the outside.

One known manufacturing process of the discontinuous metal tape is disclosed in U.S. Pat. No. 7,923,641. Numerous conductive patches are attached to the substrate through printing, fusing, transferring, bonding, vapor depositing, imprinting, coating, or other methods after the substrate is provided and its shape has been fixed. Another known process is disclosed in U.S. Pat. No. 8,558,115. A continuous metal screening tape is formed, and its shape has been fixed, and then the conductive layer is cut by laser to remove a part of the conductive layer to form gaps. Yet another known process is disclosed in U.S. Pat. No. 9,412,498. Numerous cut metal sheets are fixed onto the substrate by adhesive after the substrate is manufactured and its shape has been fixed. Also, in U.S. patent Ser. No. 10/517,198, a continuous metal screening tape is formed and its shape has been fixed, and then the conductive layer are cut by laser to remove a part of the conductive layer to form gaps.

In the above-mentioned known manufacturing processes, the discontinuous metal screening tape is manufactured with die cutting, laser ablation, adhesive sheet, spray coating, or vapor depositing process. Each of these processes has its own drawbacks. For instance, by cutting the conductive layer on the continuous metal screening tape via the die, the cutting shape is limited to the direction of the die, a certain thickness of the conductive layer is required for properly applying pressure, the width of the cut gap is hard to control, and the separation cannot always be achieved properly. Regarding the adhesive sheet process, the cut metal sheets are extremely thin, so they require additional support sheet to increase mechanical strength for processing, and thus increasing the overall thickness of the metal screening tape. As for the laser ablation process, the energy of laser is used to ablate the conductive layer on the substrate having fixed shape to form gaps. When the conductive layer gets thicker, the depth of laser ablation is difficult to control and the substrate can be damaged easily. Regarding the spray coating process, layers of conductive particles are sequentially stacked on the substrate having fixed shape to form the conductive region. Since a desirable thickness must be obtained through multilayer spraying while commencing continuous production, multiple spraying equipment along the production line are required or one equipment is used to spray back and forth multiple times. Regarding the vapor depositing process, the metal is ionized with high energy and then depositing onto the substrate having fixed shape. The process of depositing requires an enclosed environment, which makes it difficult to conduct continuous production.

Moreover, the above-mentioned known processes also share common characteristics including uniform and repetitive shape and arrangement of the conductive sections, which has some drawbacks like incurring resonance of natural frequency easily, causing transmission line impedance or return loss, and generating peak waves when the working frequency is the same as the natural frequency. The conductive sections on the substrate in the known processes are not grounded and are large in their area sizes, so a massive amount of induced charges still accumulate under high intensity electric field, resulting in high intensity induced electric field. The risk of insulation failure by punch-through short circuit is increased.

### SUMMARY

In view of the above-mentioned problems, the present invention is to provide a screening tape and manufacturing method thereof and an unshielded signal transmission cable using the same. The screening tape includes numerous conductive blocks that are mechanically and electrically isolated from each other and are electrically isolated from a common ground. The conductive blocks in the screening tape are formed in high density and have small area size. Comparing to known unshielded signal transmission cables, the electromagnetic interference can be effectively reduced, and the amount of induced charge accumulation at each conductive block can be mitigated without grounding. The induced charges can be lowered and thus the high intensity electric field would not be generated, and therefore the risk of insulation failure by punch-through short circuit is lowered.

According to one aspect of the invention, an unshielded signal transmission cable for transmitting analog or digital signals is provided. The unshielded signal transmission cable includes at least one transmission core extending in an elongated direction, at least one screening tape wrapping the at least one transmission core, and an outer jacket covering the at least one screening tape in the elongated direction. The at least one screening tape includes numerous conductive blocks that are mechanically and electrically isolated from each other and are electrically isolated from a common ground.

In one embodiment, each of the conductive blocks has multiple irregular edges.

In one embodiment, the conductive blocks have different area sizes.

In one embodiment, the at least one screening tape includes an insulating substrate, a conductive layer, and an adhesion layer. The conductive layer is parallel to the insulating substrate and includes the conductive blocks. The adhesion layer is disposed between the conductive layer and the insulating substrate to bond the conductive layer and the insulating substrate. The adhesion layer is provided in a discontinuous manner.

According to another aspect of the invention, a screening tape for using in an unshielded signal transmission cable for transmitting analog or digital signals is provided. The screening tape includes an insulating substrate, a conductive layer, and an adhesion layer. The insulating substrate has a continuous flat surface. The conductive layer is parallel to the continuous flat surface and includes numerous conductive blocks that are mechanically and electrically isolated from each other and are electrically isolated from a common ground. The adhesion layer is disposed between the conductive layer and the insulating substrate to bond the conductive layer and the insulating substrate. The adhesion layer is provided in a discontinuous manner.

In one embodiment, each of the conductive blocks has multiple irregular edges.

In one embodiment, each of the conductive blocks has an irregular shape.

In one embodiment, the conductive blocks have different area sizes.

In one embodiment, the conductive blocks have different gap sizes.

In one embodiment, the adhesion layer includes numerous adhesion blocks that are isolated from each other, and the conductive blocks are fixed to the insulating substrate through the adhesion blocks.

In one embodiment, each of the adhesion blocks is a square, a circle, a parallelogram, a hexagon, a triangle, or a rectangle.

In one embodiment, the adhesion blocks are arranged in a grid, a matrix, a pattern of a honeycomb, or a pattern of a brick wall.

In one embodiment, the adhesion blocks are provided by way of screen printing.

According to another aspect of the invention, a manufacturing method of a screening tape for using in an unshielded signal transmission cable for transmitting analog or digital signals is provided. The manufacturing method includes the following steps. First, an insulating substrate having a continuous flat surface is provided. Second, a conductive layer is provided. Further, an adhesion layer is provided in a discontinuous manner on the continuous flat surface of the insulating substrate or on the conductive layer. Afterward, the conductive layer and the insulating substrate are bonded together through the adhesion layer to form a laminated structure including the insulating substrate, the adhesion layer, and the conductive layer. Then, the laminated structure is stretched to divide the conductive layer into numerous conductive blocks that are mechanically and electrically isolated from each other and are electrically isolated from a common ground.

In one embodiment, in the step of stretching the laminated structure, the laminated structure is stretched in more than one stretching direction.

In one embodiment, in the step of stretching the laminated structure, the laminated structure is stretched by a set of stretching rollers having at least one speed differentiation.

In one embodiment, in the step of stretching the laminated structure, the laminated structure is stretched by a set of stretching rollers having at least two different diameters.

In one embodiment, in the step of stretching the laminated structure, the laminated structure is stretched by at least one pair of clips respectively engaging at two opposite sides of the laminated structure.

In one embodiment, the insulating substrate has a first stretching ratio and the conductive layer has a second stretching ratio smaller than the first stretching ratio.

According to the disclosure of the embodiments of the invention, high-density and small area size conductive blocks are included in the discontinuous metal screening tape, and the electromagnetic interference is mitigated in comparison to the known unshielded signal transmission cables.

### BRIEF DESCRIPTION OF DRAWINGS

The invention can be more fully understood by reading the following detailed description of the embodiment, with reference made to the accompanying drawings as follows:

FIG. 1 is a schematic diagram of an unshielded signal transmission cable according to one embodiment of the invention;

FIG. 2 is a cross-sectional view of the unshielded signal transmission cable of FIG. 1;

FIG. 3 is a flow chart of a manufacturing method of a screening tape for using in an unshielded signal transmission cable according to one embodiment of the invention;

FIGS. 4a-4c are respectively a top view, a three-dimensional view, and a side view of the insulating substrate of the present embodiment;

FIGS. 5a-5c are respectively a top view, a three-dimensional view, and a side view of the conductive layer of the present embodiment

FIGS. 6a-6c are respectively a top view, a three-dimensional view, and a side view of the insulating substrate with the adhesion layer disposed thereon;

FIG. 7 is an image showing the shapes and patterns of the adhesion blocks;

FIGS. 8a-8c are respectively a top view, a three-dimensional view, and a side view of a laminated structure;

FIGS. 9a-9c are respectively a top view, a three-dimensional view, and a side view of the laminated structure after being stretched.

FIG. 10 is a schematic diagram showing the laminated structure being stretch by a set of stretching rollers;

FIG. 11 is a schematic diagram showing the laminated structure being stretched by at least one pair of clips respectively engaging to two opposite sides of the laminated structure; and

FIG. 12 is a schematic diagram showing the insulating substrate being stretched by the set of stretching rollers and the pair of clips.

### DETAILED DESCRIPTION

According to the embodiments of the invention, a screening tape and a manufacturing method thereof and a signal transmission cable using the same are provided. More particularly, the present invention relates to a screening tape and a manufacturing method thereof and an unshielded signal transmission cable using the same. The unshielded signal transmission cable is used for transmitting analog or digital signals and comprises at least one transmission core, at least one screening tape, and an outer jacket. The screening tape includes numerous conductive blocks that are mechanically and electrically isolated from each other, and the conductive blocks are electrically isolated from a common ground. The conductive blocks in the screening tape are formed in high density and have small area size, so the amount of induced charges accumulation at the conductive blocks can be mitigated without grounding, and the electromagnetic interference can be effectively reduced. The induced charges can also be lowered, and the high intensity electric field would not be generated. The risk of insulation failure by punch-through short circuit can be lowered.

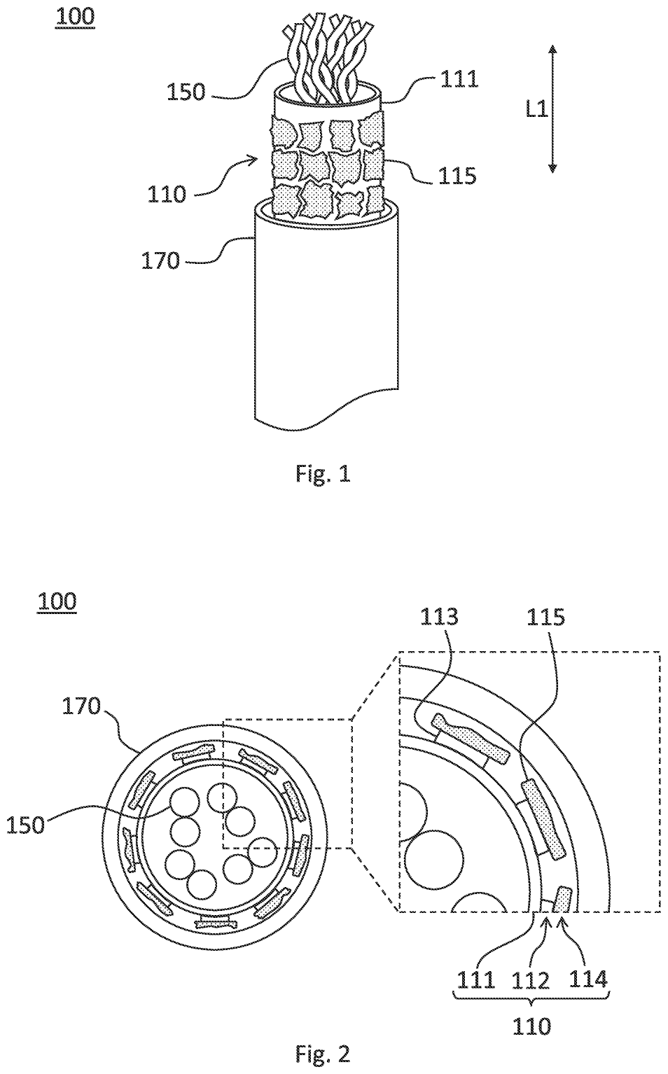

Please refer to FIG. 1 and FIG. 2 at the same time. FIG. 1 is a schematic diagram of an unshielded signal transmission cable according to one embodiment of the invention. FIG. 2 is a cross-sectional view of the unshielded signal transmission cable of FIG. 1.

The unshielded signal transmission cable 100 is used for transmitting analog or digital signals. The unshielded signal transmission cable 100 can be exemplified by a local area network (LAN) cable or any other unshielded cables. The unshielded signal transmission cable 100 includes at least one transmission core 150, at least one screening tape 110, and an outer jacket 170. The transmission core 150 extends in an elongated direction L1. It is to be noted that although four twisted pairs are shown in FIG. 1, it is not intended to limit the invention. Any other number of twisted pairs can be used in the unshielded signal transmission cable 100. In other embodiments, the transmission core 150 can be twisted pair, twin wires, or other suitable transmission cores, depending on the practical product requirement, and the transmission core 150 is protected by the screening tape 110. In another embodiment, the unshielded signal transmission cable 100 can include only one twisted pair 150 which is wrapped by one screening tape 110. In yet another embodiment, the unshielded signal transmission cable 100 includes more than one twisted pairs 150 and more than one screening tapes 110, and each twisted pair 150 is wrapped by one screening tape 110.

In the unshielded signal transmission cable 100 of the present embodiment, one screening tape 110 wraps around the transmission core 150 and includes numerous conductive blocks 115. The conductive blocks 115 are mechanically and electrically isolated from each other. Also, the conductive blocks 115 are electrically isolated from a common ground, that is, they are provided without grounding. The outer jacket 170 covers the screening tape 110 in the elongated direction L1.

More specifically, the screening tape 110 has a three-layer structure which includes an insulating substrate 111, an adhesion layer 112, and a conductive layer 114. The conductive layer 114 is parallel to the insulating substrate 111. The adhesion layer 112 is disposed between the conductive layer 114 and the insulating substrate 111, so as to bond the conductive layer 114 and the insulating substrate 111. In the present embodiment, the adhesion layer 112 is disposed on the insulating substrate 111. The conductive layer 114 is fixed to the insulating substrate 111 through the adhesion layer 112. The adhesion layer 112 is provided in a discontinuous manner on the insulating substrate 111. In another embodiment, the adhesion layer 112 is disposed on the conductive layer 114 and is provided with a discontinuous manner on the conductive layer 114. The conductive layer 114 includes the conductive blocks 115. In one embodiment, the conductive layer 114 (including the conductive blocks 115) includes metal, such as Al, Cu, Ag, or alloys thereof, or graphite. The insulating substrate 110 is made of plastic or dielectric material, such as PET, PVC, PP, PE, or other suitable polymers.

In the present embodiment, the conductive blocks 115 is formed by way of having different area sizes, and each of the conductive blocks 115 has multiple irregular edges. The screening tape 110 in the present embodiment is exemplified by a discontinuous (discontinuous conductive layer 114) metal screening tape 110, which can also be regarded as a formless discrete screening tape 110. The unshielded signal transmission cable 100 includes the high density, small size, irregular, and isolated conductive blocks 115 in the screening tape 110, so the electromagnetic interference can be alleviated with reduced charge accumulation at each conductive block. Therefore, the induced charges can be lowered, and a high-intensity electric field can be avoided prevented without any grounding. The risk of insulation failure by punch-through short circuit can be reduced. Further, the alien cross-talk between the unshielded signal transmission cable 100 and a neighboring cable can be mitigated as well.

In addition, by using the high density, small size, irregular, and isolated conductive blocks 115, the generation of natural frequency can be effectively delayed without any grounding means, e.g. not being generated until 2 GHz. The impedance and return loss of the unshielded signal transmission cable 100 can be improved accordingly, and the peak waves that appears when the working frequency is equal to the natural frequency can be eliminated.

A manufacturing method of a screening tape is now elaborated according to one embodiment of the invention.

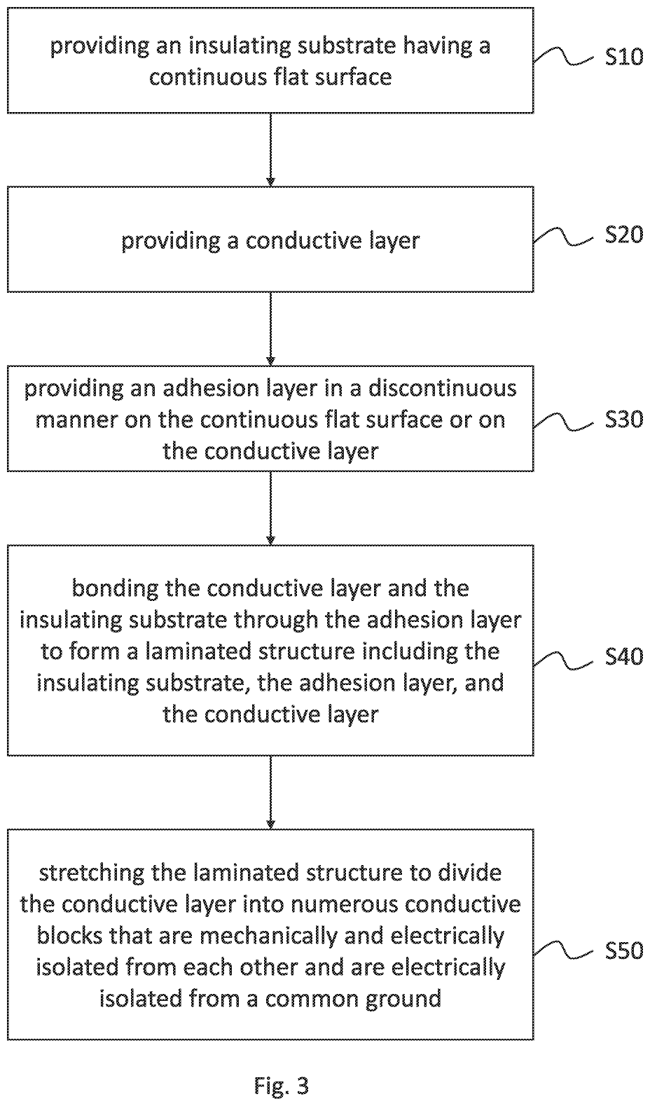

Please refer to FIG. 3, which is a flow chart of a manufacturing method of a screening tape for using in an unshielded signal transmission cable according to one embodiment of the invention. To clearly show the features of the invention, the manufacture method of the screening tape 110 in the above embodiment (as shown in FIG. 1 and FIG. 2) is elaborated. The screening tape 110 is used in the unshielded, non-grounding signal transmission cable 100 for transmitting analog or digital signals.

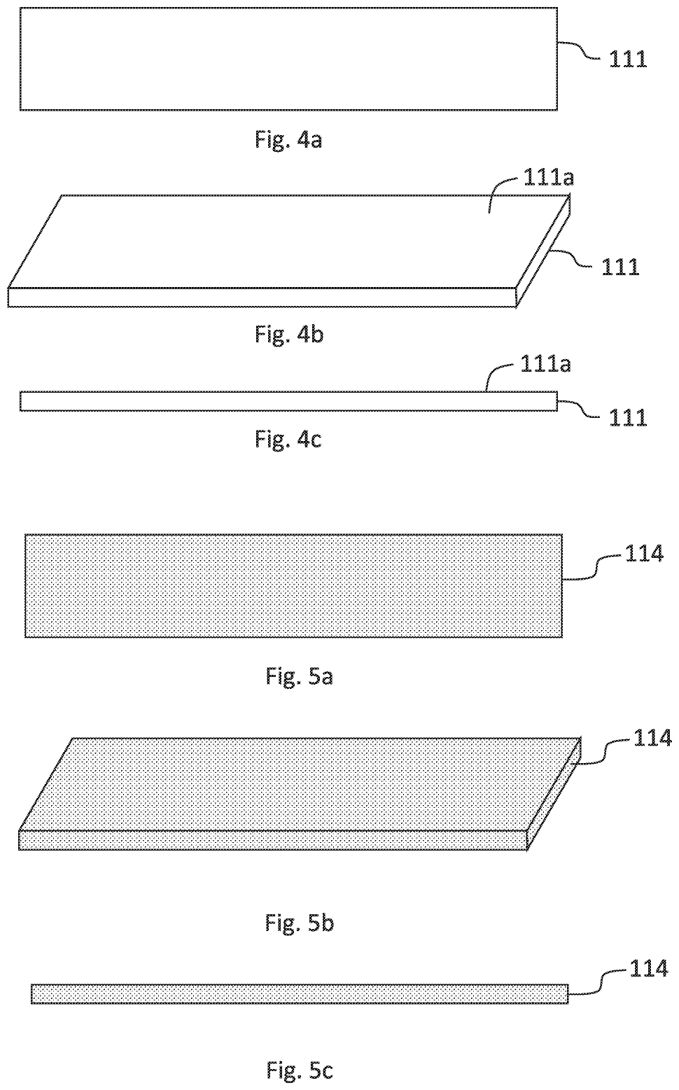

First, as shown in step S10, an insulating substrate having a continuous flat surface is provided. Please refer to FIGS. 4a-4c, which are respectively a top view, a three-dimensional view, and a side view of the insulating substrate of the present embodiment. The insulating substrate 111 has the continuous flat surface 111a.

Second, as shown in step S20, a conductive layer is provided. Please refer to FIGS. 5a-5c, which are respectively a top view, a three-dimensional view, and a side view of the conductive layer of the present embodiment. The conductive layer 114 is a continuous layer and is made of a metal material such as aluminum (Al), copper (Cu), silver (Ag), or their alloys; in another embodiment, the conductive layer 114 can be made of graphite.

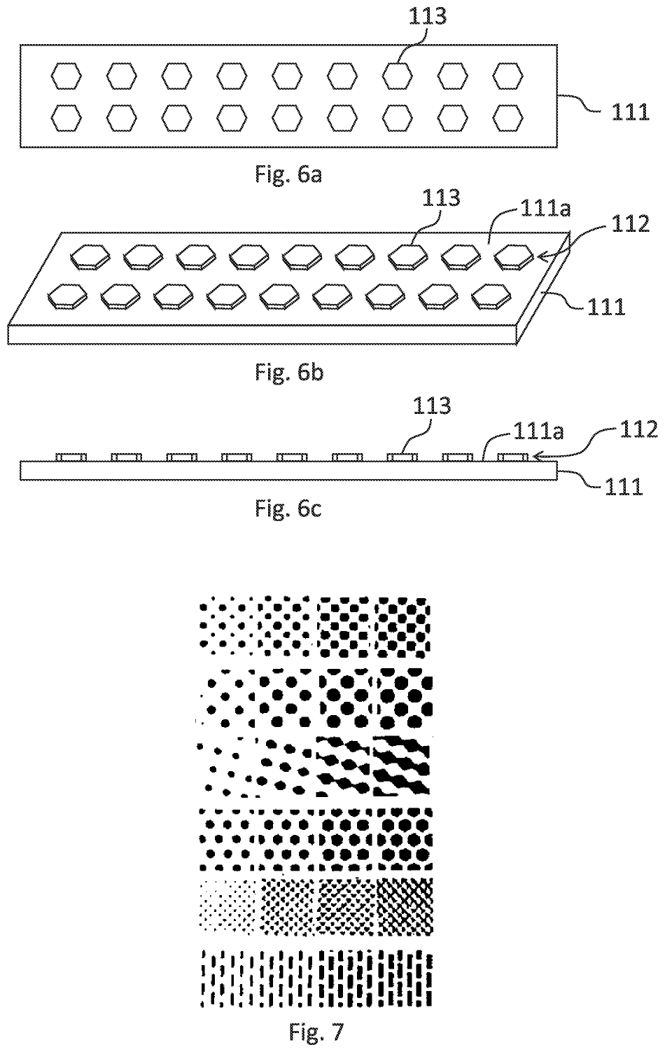

Then, as shown in step S30, an adhesion layer 112 is provided in a discontinuous manner on the continuous flat surface 111a of the insulating substrate 111 or on the conductive layer 114. Please refer to FIGS. 6a-6c, which are respectively a top view, a three-dimensional view, and a side view of the insulating substrate with the adhesion layer disposed thereon. Regarding how to provide the adhesion layer 112 in the discontinuous manner, in one embodiment, the adhesion layer 112 is screen printed onto the continuous flat surface 111a of the insulating substrate 111. The adhesion layer 112 includes numerous adhesion blocks 113 that are isolated (or regarded as separated) from each other. In another embodiment, the adhesion layer 112 can firstly be fully coated on the insulating substrate 111 and then partially removed to form the adhesion blocks 113. In fact, any other methods that directly or indirectly forms the adhesion blocks 113 on the insulating substrate 111 falls within the scope of the discontinuous manner of the invention.

More details relating to the discontinuous manner of providing the adhesion layer 112 is elaborated below. The shape of the adhesion blocks 113 can each be a square, a circle, a parallelogram, a hexagon, a triangle, a rectangle, or other geometric shapes. The adhesion blocks 113 can be arranged in a grid, a matrix, a pattern of a honeycomb, or a pattern of a brick wall. Please refer to FIG. 7, which is an image showing the shapes and patterns of the adhesion blocks. There are total 24 pattern examples in FIG. 7, including 6 rows and 4 patterns in each row. According to the four patterns in the first row of FIG. 7, the adhesion blocks 113 are square and arranged in a grid. The four patterns in the second row show that the adhesion blocks 113 are round and arranged in a grid. The four patterns in the third row show that the adhesion blocks 113 are parallelogram and arranged in a matrix. The four patterns in the fourth row show that the adhesion blocks 113 are hexagon and arranged in a pattern like honeycomb. The four patterns in the fifth row show that the adhesion blocks 113 are triangle and arranged in a grid. The four patterns in the last row show that the adhesion blocks 113 are rectangle and arranged in a pattern like a brick wall.

According to the above, no matter what shapes the adhesion blocks 113 are or what patterns they are arranged in, the insulating substrate 111 is not fully covered by the adhesion layer 112 in the embodiments of the invention.

In the present embodiment, the adhesion layer 112 is provided on the continuous flat surface 111a of the insulating substrate 111; however, the feature of the present invention is not limited thereto. In another embodiment, the adhesion layer 112 can be provided on the conductive layer 114, and the characters and features of the adhesion layer 112 on the conductive layer 114 corresponds to that on the insulating substrate 111 and will not be repeated again. As long as the adhesion layer 112 is provide in a discontinuous manner, it falls within the scope of the invention.

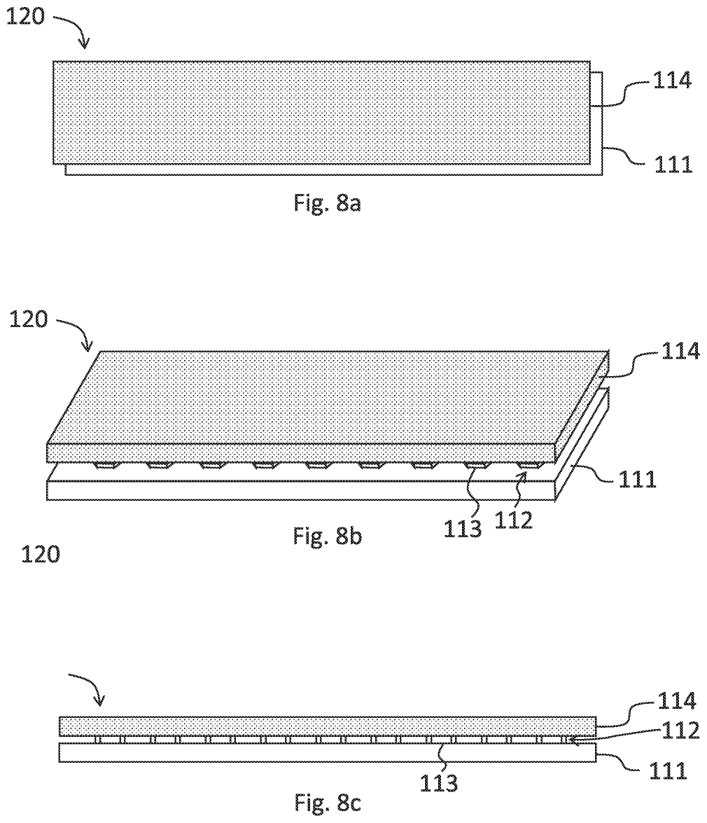

Next, the manufacturing method moves on to step S40 of FIG. 3. The conductive layer 114 and the insulating substrate 111 is bonded through the adhesion layer 112 to form a laminated structure 120. The laminated structure 120 includes the insulating substrate 111, the adhesion layer 112, and the conductive layer 114, which is a three-layer structure in the present embodiment. Please refer to FIGS. 8a-8c, which are respectively a top view, a three-dimensional view, and a side view of the laminated structure. In one embodiment, the conductive layer 114 is a continuous layer parallel to the insulating substrate 111 and is made of a metal material such as aluminum (Al), copper (Cu), silver (Ag), or their alloys. Some parts of the conductive layer 114 are fixed to the adhesion blocks 113 of the adhesion layer 112 and other parts are not, so the conductive layer 114 is partially adhered to the adhesion layer 112.

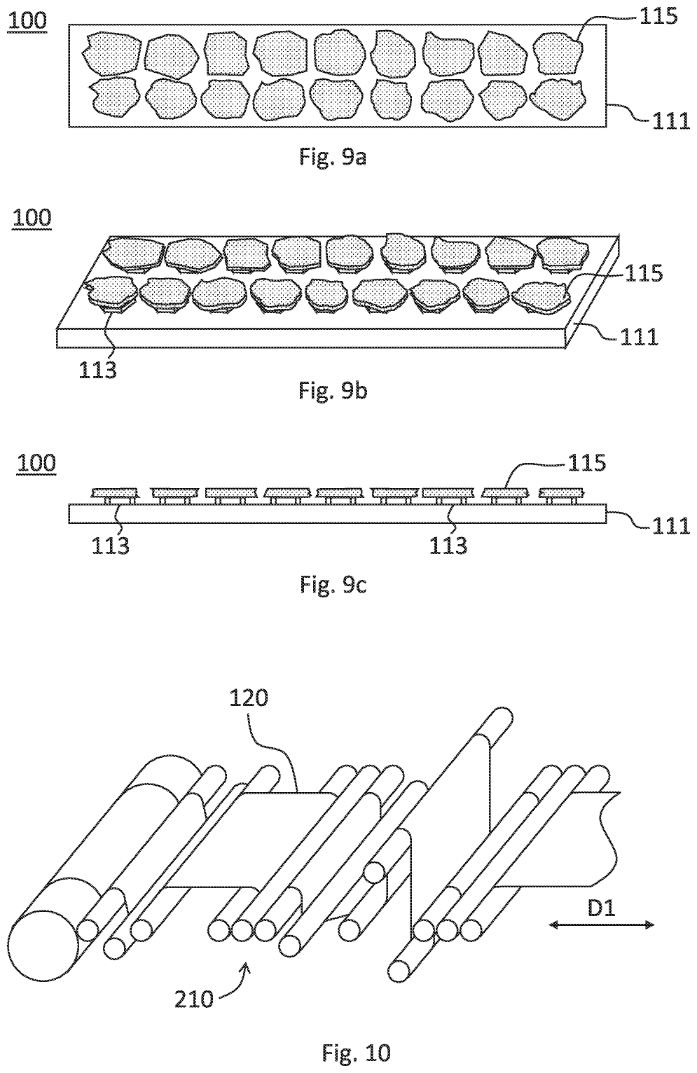

Afterwards, the manufacturing method continues to step S50 of FIG. 3. The laminated structure 120 is stretched to divide the conductive layer 114 into numerous conductive blocks 115 that are mechanically and electrically isolated from each other. The conductive blocks 115 are provided without grounding and are isolated from the common ground. Please refer to FIGS. 9a-9c, which are respectively a top view, a three-dimensional view, and a side view of the laminated structure after being stretched. In the present embodiment, the insulating substrate 111 has a first stretching ratio and the conductive layer 114 has a second stretching ratio, and the second stretching ratio is smaller than the first stretching ratio. When the insulating substrate 111 is stretched to the extent beyond the limit of the conductive layer 114, the parts of the conductive layer 114 that are not fixed to the underlying adhesion blocks 113 will crack or fracture due to its weak tension tolerance. The conductive layer 114 then divides into numerous small conductive blocks 115, and the conductive blocks 115 are fixed to the insulating substrate 111 through the adhesion blocks 113.

In one embodiment, the laminated structure 120 is stretch in a first stretching direction in step S50 of FIG. 3. Please refer to FIG. 10, which is a schematic diagram showing the laminated structure being stretch by a set of stretching rollers. The set of stretching rollers 210 has at least one speed differentiation. There is a speed differentiation between two stretching rollers in the set of stretching rollers 210. For example, the set of stretching rollers 210 includes two winders and accompanying casting rollers, and there is a speed differentiation between two winders to stretch the laminated structure 120. In FIG. 10, the laminated structure is stretched in the longitudinal direction of the length thereof, which is the first stretching direction D1. The conductive layer 114 fractures substantially along the first stretching direction D1.

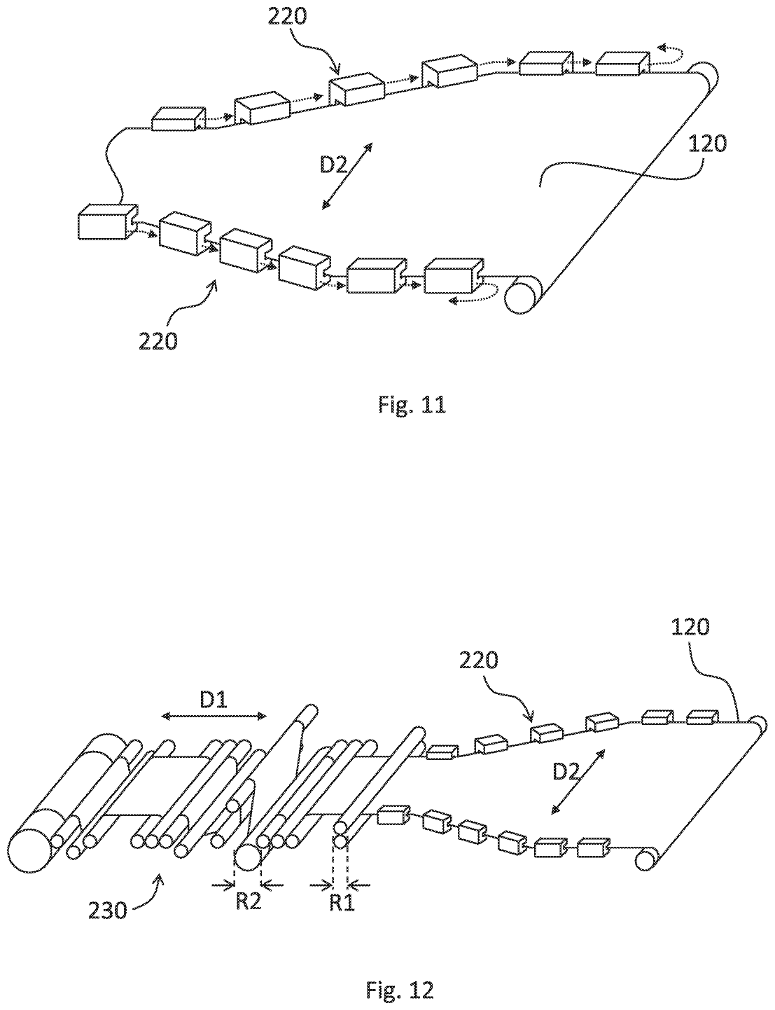

In another embodiment, the laminated structure 120 is stretched in a second stretching direction in step S50 of FIG. 3. Please refer to FIG. 11, which is a schematic diagram showing the laminated structure being stretched by at least one pair of clips respectively engaging to two opposite sides of the laminated structure 120. As shown in FIG. 11, the laminated structure 120 is stretched in the transverse direction of the width thereof, which is the second stretching direction D2 perpendicular to the first stretching direction D1. In the example of FIG. 11, the laminated structure 120 is stretched by more than one pair of clips 220 (e.g. tenter clips) respectively engaging to two opposite sides of the laminated structure 120, so the laminated structure 120 is stretched in the width direction. The conductive layer 114 fractures substantially along the second stretching direction D2.

In yet another embodiment, the laminated structure 120 is stretched in more than one stretching direction in step S50 of FIG. 3. Please refer to FIG. 12, which is a schematic diagram showing the laminated structure being stretched by the set of stretching rollers and the pairs of clips. In this embodiment, the laminated structure 120 is stretched biaxially. The laminated structure 120 is stretched in the first stretching direction D1 by the set of rollers 230 and in the second stretching direction D2 by the sets of clips 220 in a continuous flow. The set of stretching rollers 230 has at least two different diameters, such as the smaller first diameter R1 and larger second diameter R2 shown in FIG. 12. The conductive layer 114 then fractures along both the first stretching direction D1 and the second stretching direction D2, thereby forming the conductive blocks 115.

Due to the process of crack or fracture of the conductive layer 114, each of the conductive blocks 115 has an irregular shape and has multiple irregular edges. The conductive blocks 115 have different area sizes and different gap widths.

According to the embodiments of the invention, a discontinuous metal screening tape having formless (irregular shape) discrete (isolated) conductive blocks and a manufacturing method thereof and a signal transmission cable using the same are provided. The signal transmission cable is provided without grounding and therefore is an unshielded cable. The discontinuous adhesion layer is provided on the insulating substrate. By controlling the shape, size, and pattern of the discontinuous adhesion layer, the conductive layer is partially adhered to the insulating substrate. In addition, by using the insulating substrate which has the first stretching ratio higher than the second stretching ratio of the conductive layer, the conductive layer can be stretched and cracked or fractured into numerous conductive blocks by mechanical stretching. In this manner, the discontinuous metal screening tape includes conductive blocks having different shapes and sizes, and the gaps between conductive blocks are not uniform (i.e. the gaps have different widths). The distances between conductive blocks can be generally controlled by the pulling force of the mechanical stretching.

In the embodiments of the invention, the adhesion layer is provided on the insulating substrate by way of screen printing as an example, so the adhesion layer includes numerous adhesion blocks that are isolated (i.e. separated) from each other, as detailed in the above that the adhesion layer is provided in the discontinuous manner. The shape of the adhesion blocks can be square, circle, parallelogram, hexagon, triangle, rectangle, or a various of geometric shapes. The adhesion blocks can be arranged in the pattern such as grid, matrix, patterns like honeycomb, or patterns like brick wall. That is to say, the adhesion layer is disposed on the substrate in the form of small area adhesion blocks, and gaps are provided between the adhesion blocks. The insulating substrate is not fully covered by the adhesion layer. In another embodiment. the adhesion layer is not provided on the insulating substrate; on the contrary, it is provided on the conductive layer with the discontinuous manner.

The stretching ratio of the conductive layer (the second stretching ratio) is smaller than the stretching ratio of the substrate (the first stretching ratio). When the insulating substrate is stretched to the extent beyond the limit of the conductive layer, the portions of the conductive layer without fixing to the underlying adhesion blocks will crack due to its weak tension tolerance. The conductive layer then fractures into numerous small conductive blocks. The distance between the conductive blocks can be controlled by adjusting the stretching degree of the insulating substrate.

Regarding the mechanical stretching, the biaxial stretching can be used in one embodiment. For example, the insulating substrate with the adhesion layer and the conductive layer disposed thereon (i.e. the laminated structure; also called the semi-finished continuous metal screening tape) is firstly stretched in the longitudinal direction of length (the first stretching direction) by a set of stretching rollers having at least one speed differentiation or having at least two different diameters. The conductive layer fractures substantially in the longitudinal direction, so a group of gaps are generally formed along the length of the insulating substrate. Secondly, the substrate with the conductive and adhesion layers (i.e. the laminated structure) is stretched in the transverse direction of width (the second stretching direction) by more than one pair of clips engaging to two opposite sides of the laminated structure, so the laminated structure is stretched in the width direction and another group of gaps are generally formed along the width of the insulating substrate. As a result, the conductive layer can be divided into mechanically and electrically isolated conductive blocks through the groups of gaps. In another embodiment, the stretches in the first stretching direction and in the second stretching direction can be a continuous flow.

Since the extent of stretching the laminated structure is not uniform, some parts of the laminated structure extend more than others, the conductive layer on the insulating substrate fractures into various sizes of conductive blocks. Furthermore, due to the process of cracking and fracturing, the divided conductive blocks have irregular shapes, different area sizes, and multiple irregular edges. The non-uniform extension of the laminated structure also results in different gap widths of the conductive blocks. After the stretching steps, the discontinuous metal screening tape of formless and discrete conductive blocks is then completed.

The embodiments of the invention provide an improved manufacturing method of metal screening tape, which can be utilized for massive continuous production without the need of adding expensive equipment, and no significant cost will be added.

In one embodiment, the screening tape can be used in an unshielded signal transmission cable such as a local area network (LAN) cable for commercial buildings, industrial premises, or data centers where multiple cables are bundled together. The unshielded signal transmission cable includes one or more twisted pairs. Each twisted pair is wrapped by the discontinuous metal screening tape of formless and discrete conductive blocks that are provided without grounding. The discontinuous metal screening tape is used to screen the external electromagnetic interferences and the mutual interferences between unshielded cables. The outer jacket is provided to cover the discontinuous metal screening tape. In one embodiment, the outer jacket is an insulating sheath. The discontinuous metal screening tape includes the insulating substrate, the adhesion layer, and the conductive blocks. The conductive blocks are fixed to the surface of the insulating substrate through the adhesion layer, so as to block the external electromagnetic field from affecting the internal transmission lines of the unshielded signal transmission cable. Also, the electromagnetic interference to the external equipment from the radiation of internal signal of the unshielded signal transmission cable can be prevented.

According to the embodiments of the invention, a screening tape and a manufacturing method thereof and an unshielded signal transmission cable using the same are provided. The unshielded signal transmission cable is used for transmitting analog or digital signals and comprises at least one transmission core, at least one screening tape, and an outer jacket. The screening tape includes numerous conductive blocks that are mechanically and electrically isolated from each other. The conductive blocks in the screening tape are formed in high density and have small area size, so the amount of induced charge accumulation at the conductive blocks can be mitigated without grounding, and the electromagnetic interference can be effectively reduced. The induced charges can also be lowered, and the high intensity electric field would not be generated. The risk of insulation failure by punch-through short circuit be lowered. According to the disclosure of the embodiments of the invention, high-density and small area size conductive blocks are included in the discontinuous metal screening tape, and the electromagnetic interference is mitigated in comparison to the known unshielded signal transmission cables. The generation of natural frequencies can be effectively delayed without grounding. Therefore, the impedance and the return loss can be improved, and the peak waves that appears when the working frequency equals the natural frequency can be eliminated.

The ordinal numbers used in the detailed description and claims, such as “first” and “second” do not necessarily indicate their priority orders or up and down directions; on the contrary, they are merely intended to distinguish different elements. It will be apparent to those skilled in the art that various modifications and variations can be made to the structure of the present invention without departing from the scope or spirit of the invention. In view of the foregoing, it is intended that the present invention covers modifications and variations of this invention, provided they fall within the scope of the following claims.

1. An unshielded signal transmission cable for transmitting analog or digital signals, comprising:
at least one transmission core extending in an elongated direction;
at least one screening tape wrapping the at least one transmission core, wherein the at least one screening tape comprising a plurality of conductive blocks that are mechanically and electrically isolated from each other and are electrically isolated from a common ground; and
an outer jacket covering the at least one screening tape in the elongated direction.

2. The unshielded signal transmission cable of claim 1, wherein each of the conductive blocks has a plurality of irregular edges.

3. The unshielded signal transmission cable of claim 1, wherein the conductive blocks have different area sizes.

4. The unshielded signal transmission cable of claim 1, wherein the at least one screening tape comprises:
an insulating substrate;
a conductive layer being parallel to the insulating substrate and comprising the conductive blocks; and
an adhesion layer disposed between the conductive layer and the insulating substrate to bond the conductive layer and the insulating substrate, wherein the adhesion layer is provided in a discontinuous manner.

5. A screening tape for using in an unshielded signal transmission cable for transmitting analog or digital signals, the screening tape comprising:
an insulating substrate having a continuous flat surface;
a conductive layer being parallel to the continuous flat surface, wherein the conductive layer comprises a plurality of conductive blocks that are mechanically and electrically isolated from each other and are electrically isolated from a common ground; and
an adhesion layer disposed between the conductive layer and the insulating substrate to bond the conductive layer and the insulating substrate, wherein the adhesion layer is provided in a discontinuous manner.

6. The screening tape of claim 5, wherein each of the conductive blocks has a plurality of irregular edges.

7. The screening tape of claim 5, wherein each of the conductive blocks has an irregular shape.

8. The screening tape of claim 5, wherein the conductive blocks have different area sizes.

9. The screening tape of claim 5, wherein the conductive blocks have different gap widths.

10. The screening tape of claim 5, wherein the adhesion layer comprises a plurality of adhesion blocks that are isolated from each other, and the conductive blocks are fixed to the insulating substrate through the adhesion blocks.

11. The screening tape of claim 10, wherein each of the adhesion blocks is a square, a circle, a parallelogram, a hexagon, a triangle, or a rectangle.

12. The screening tape of claim 10, wherein the adhesion blocks are arranged in a grid, a matrix, a pattern of a honeycomb, or a pattern of a brick wall.

13. The screening tape of claim 10, wherein the adhesion blocks are provided by way of screen printing.

14. A manufacturing method of a screening tape for using in an unshielded signal transmission cable without a drain wire for transmitting analog or digital signals, the manufacturing method comprising:
providing an insulating substrate having a continuous flat surface;
providing a continuous conductive layer;
providing an adhesion layer in a discontinuous manner on the continuous flat surface of the insulating substrate or on the continuous conductive layer;
bonding the continuous conductive layer and the insulating substrate through the adhesion layer to form a laminated structure comprising the insulating substrate, the adhesion layer, and the continuous conductive layer; and
stretching the laminated structure in a longitudinal direction of the laminated structure to divide the continuous conductive layer into a plurality of discrete conductive blocks that are mechanically and electrically isolated from each other.

15. The manufacturing method of the screening tape of claim 14, wherein in the step of stretching the laminated structure, the laminated structure is stretched in more than one stretching direction.

16. The manufacturing method of the screening tape of claim 14, wherein in the step of stretching the laminated structure, the laminated structure is stretched by a set of stretching rollers having at least one speed differentiation.

17. The manufacturing method of the screening tape of claim 14, wherein in the step of stretching the laminated structure, the laminated structure is stretched by a set of stretching rollers having at least two different diameters.

18. The manufacturing method of the screening tape of claim 14, wherein in the step of stretching the laminated structure, the laminated structure is stretched by at least one pair of clips respectively engaging to two opposite sides of the laminated structure.

19. The manufacturing method of the screening tape of claim 14, wherein the insulating substrate has a first stretching ratio and the conductive layer has a second stretching ratio smaller than the first stretching ratio.
